(19) United States
(12) Patent Application Publication
(10) Pub. No.: US 2025/0065382 A1
(43) Pub. Date: Feb. 27, 2025

(54) USING PHOTONICS TO RECOVER CRITICAL MATERIALS FROM AUTOMOTIVE SHREDDER RESIDUE AND SIMILAR MIXED PLASTIC WASTE

(71) Applicant: Grensol AG, Thalwil (CH)

(72) Inventors: Bhawna Nagar, Ferney-Voltaire (FR); Hubert Girault, Ropraz (CH); Rajiv Singhal, Thalwil (CH)

(21) Appl. No.: 18/811,184

(22) Filed: Aug. 21, 2024

Related U.S. Application Data
(60) Provisional application No. 63/578,026, filed on Aug. 22, 2023.

(51) Int. Cl. B09B 3/50; B07B 4/02; B09B 3/35; B09B 3/40; B09B 101/05

(52) U.S. Cl. CPC B09B 3/50; B07B 4/02; B09B 3/35; B09B 3/40; B09B 2101/05

(57) ABSTRACT

Waste feed material, such as Automotive Shredder Residue (ASR) feed material, that includes hydrocarbon materials and inorganic materials is processed using photolysis. A reactor includes a chamber that receives waste feed material including a majority of hydrocarbon material after the substantial removal of inorganic material including metals and minerals. A photonic illumination or photolysis module irradiates the feed material within the chamber of the reactor to decompose the hydrocarbon or hydrocarbon materials within the waste feed material into gases and/or carbonaceous solids. A mechanical movement unit moves the waste feed material within the chamber of the reactor to facilitate exposure of different portions of the feed material to irradiation within the chamber during system operation. A pre-treatment module substantially removes the contained metals and minerals in the waste material from the hydrocarbon material fed to the reactor.

### CROSS-REFERENCE TO RELATED APPLICATION

This application claims priority from U.S. Provisional Patent Application No. 63/578,026, filed Aug. 22, 2023, the entire disclosure of which is incorporated herein by reference.

### FIELD OF THE INVENTION

The present invention relates to recovering critical materials (e.g., metals, minerals and hydrocarbons) from the waste generated from the recycling of end-of-life motor vehicles and other types of mixed plastic waste.

### BACKGROUND

Approximately two billion motor vehicles are estimated to be in operation across the world by 2030. In 2022, more than 80 million vehicles were sold globally. Of these sales, approximately 57% constituted passenger cars, while commercial vehicles accounted for around 24% of the total. Their end-of-life management is one of the big concerns considering the environmental complexity they pose due to their nonhomogeneous nature and multiple types of materials used for manufacturing. End-of-life vehicle (ELV) treatment is currently based on re-use, recycle, incineration and landfill. It is broadly combined in 3 steps, starting with de-polluting which includes the removal of all fluids, oil filters, batteries, catalytic converters, etc. In the second step, the dismantling of ELV components is done to remove tires, rims, airbags, windscreen, etc. In the last step, the car bulk is shredded. This car bulk (sometimes also referred to as “hulk”) consists of ferrous metal (˜70%), non-ferrous metals (˜6%) and the Automotive Shredder Residue (ASR) waste or auto-fluff (˜20-25%). The shredded car bulk material is separated physically to recover a large part of the ferrous and other metallic constituents, and the remaining material (ASR) is usually sent for landfilling and/or incineration for disposal.

Automotive Shredder Residue (ASR) contains over 50 percent hydrocarbon materials (hereafter called ASR Hydrocarbon Fraction): shredded textiles, plastics, wood and polymers from the upholstery, seats, electrical wiring, fluid transfer, etc. ASR is extremely complex to process due to its non-homogeneous and inconsistent nature while also containing chemicals that produce toxic gases when combusted, hence is classified as hazardous waste. Problematic compounds found in ASR include polychlorinated biphenyls (PCBs). In some reports, typical PCB values range from 10-400 mg/kg in the US, but usually below 100 mg/kg. In Europe, such as in Germany, the typical values are below 10 mg/kg. One reason for elevated PCB levels is the co-shredding of ELVs with discarded refrigerators and other household equipment waste.

Apart from chlorine containing compounds like PCBs, other constituents of concern in ASR are trace elements and heavy metals. Compared to municipal solid waste (MSW), the concentration levels of these metals are approximately 10 times higher. Copper (Cu), zinc (Zn), Cadmium (Cd), and lead (Pb) are found in high amounts, with Cu levels comparable to those found in exploitable ores of copper mines. Mercury content in ASR is typically around 0.5 mg/kg, about half of what is present in the ELV before shredding (as Hg is mainly used in switches), although values up to 15 mg/kg have been reported. Cadmium (Cd) is typically found in ASR at concentrations of 10-100 mg/kg, while Pb levels are much higher, usually ranging from 500-12,000 ppm. Chromium (Cr) is typically present at levels of 200-800 mg/kg, and arsenic (As) is found around 60 mg/kg.

Over the last number of years, there has been a substantial increase in the utilization of plastic components in vehicles, reaching 350 kg per vehicle to economize fuel consumption and reduce overall vehicle weight. The conventional recycling techniques used for resource recovery from single-use plastics becomes much more complicated for this mixed plastic waste, and the increasing incorporation of new-generation plastic composites makes the current situation even worse. Reasons for limited interest in plastic recovery and recycling from ASR are (1) the high cost of segregation for secondary use, and (2) that the major plastic polymer components-polyethylene (PE), polypropylene (PP), polyvinyl chloride (PVC) and polyurethane (PU)—can be produced for primary use at very low costs.

Considering all the negative environmental impacts, as well as the resource recovery potential of ASR, many countries have been developing models and directives for effective ASR recycling and management. The European Union (EU) directive stipulated that by the beginning of 2006, 85% of the ELVs are reused/recovered and 80% is reused/recycled. This limit was further increased to 95% reuse/recovery and 85% reuse/recycle from ELVs, implying an energy recovery rate of 5 and 10% respectively by 2015. The EU is now working on new measures to increase the use of recycled plastic content where 25% of the plastic used to build a new vehicle will be required to come from recycling, of which 25% must be recycled from ELVs.

The potential for utilizing thermal treatment for processing ASR is promising, primarily because ASR possesses a considerable heating value, ranging from 14 to 30 MJ/kg. However, the fine ASR fraction, due to its small particle size, often poses challenges for mechanical recovery. Incineration of ASR alone is typically not considered due to the high ash residue content of the material and the production of high levels of toxic gases. For this reason, co-incineration of ASR, mostly with municipal solid waste, has been performed in grate furnaces, fluidized bed reactors or rotary kilns. However, higher amounts of ASR, over 40%, resulted in problems with conveyor transfer, chutes bridging and plugging, and additional issues in the feed system. Numerous challenges need to be addressed when considering incineration/co-incineration of ASR waste such as (a) high chlorine content that needs extensive dichlorination steps in order to avoid reactor corrosion and fouling, (b) high ash content causing clogging with high levels of leachable elements that need further cleaning of the solid incineration bottom ash before landfill, (c) if operational conditions and gas cleaning systems are not carefully controlled during incineration, hazardous pollutants like polychlorinated dibenzo dioxins and furans (PCDD/Fs) and polychlorinated biphenyls (PCBs) may be produced as by-products, (d) highly volatile heavy metals concentrate in either the flue gas or fine particulate, necessitating expensive flue gas cleaning systems.

In a study investigating the thermal valorization of ASR as a means of waste treatment, the emission of pollutants was observed during thermal decomposition of ASR in a laboratory-scale reactor at different temperatures and oxygen ratios (incineration and pyrolysis). Carbon oxides, light hydrocarbons, polycyclic aromatic hydrocarbons (PAHs), polychlorinated phenols (PCPhs), polychlorinated benzenes (PCBzs), polybrominated phenols (PBPhs), polybromo- and polychlorodibenzo-p-dioxins and furans (PBDD/Fs and PCDD/Fs), and dioxin-like polychlorobiphenyls (dl-PCBs) were analyzed. The researchers concluded that thermal recovery could be a viable option for achieving the waste recovery rates set by EU directives. Considering the results, it can be inferred that pyrolysis is generally a better method for minimizing the formation of pollutants. Pyrolysis at high temperatures (850° C.) resulted in maximum emissions of PAHs, which are primarily formed through pyrolytic reactions. Lower emissions of carbon oxides and light hydrocarbons were observed in pyrolytic conditions compared to combustion. However, it should be noted that the emissions of PBDD/Fs were relatively high in pyrolytic conditions, indicating that there is still room for improvement in reducing the formation of these toxic compounds.

Until now, the industrial development of ASR pyrolysis has been hindered by significant constraints, such as the following:
The major environmental issue for thermal pyrolysis of ASR and other similar feeds, is that the heat source is more often than not a non-renewable resource like coal, petroleum, and natural gas making it an unsustainable option in the long run due to the resulting fossil-based carbon emissions. Certain pyrolysis and gasification technologies use the syngas produced as the energy source to be net zero energy consumption, however they still produce carbon emissions even if the source of this carbon is from waste.
Most of the pyrolysis units utilize more energy than produced. Even with processes that have net zero energy consumption, the problem of post-production purification steps is a major drawback. The economic and commercial viability of the obtained products is compromised by the cost associated with added processing steps required to attain market purity standards. For example, tires consist of up to 30% carbon black, and their recovery is very high in demand, however poor quality due to the presence of volatiles and low yields by pyrolysis reduces commercial feasibility. Specific to ASR, the economics of the whole system are negatively affected by the relatively high cost of catalysts and the need for additional purification steps and lastly the need of a self-sufficient/self-efficient or self-powered system.
Processing challenges are caused by the elevated chlorine levels in ASR, contamination by heavy metals like lead and cadmium, challenges related to solid product or residue disposal, the expenses associated with necessary pre-treatment for reactor feeding, the reactor fouling and unpredictable fluctuations in the feed composition. Another drawback of ASR pyrolysis is the potential for high PCB levels in oil or char/solid products, leading to hazardous waste classification, and the formation of tars, a common by-product. All of these factors contribute towards low material yield and/or high processing costs.

With all the well-established pyrolysis methods and processes present, indeed there is still a need for technological advancements to maximize the production of good quality and achieve high-yields for the input materials to products within a circular economy model.

It would therefore be beneficial to develop an economically viable process to overcome the shortfalls of the current state-of-the-art waste disposal practices operating at scale, such as landfilling or incineration of industrial wastes like ASR. It would also be beneficial to recover the valuable and critical resources contained in waste like ASR to drive a circular economy, for metals, minerals and the tough-to-recycle plastics, with a quality acceptable for downstream users. Further, it would be beneficial to build a small modular system that can be located close to sites where the input waste is produced and the output feedstock is consumed, so that waste does not have to be trucked long distances.

### SUMMARY

In example embodiments, a photonic processing system for ASR or mixed plastic waste powder from end-of-life vehicles or other waste material comprises a reaction chamber including an inlet for the Hydrocarbon Fraction feed material, a solids removal outlet, a gas stream removal outlet and a heat resistant transparent window. The system further comprises a mechanical moving system to move and expose different portions of the feed material under the heat resistant transparent window through which illumination of the feed material occurs to transfer energy from a xenon lamp, predominantly by radiation, and a mechanical moving system to pass, move and expose the feed material toward and under the heat resistant transparent window through which illumination of the feed material occurs to transfer energy from the xenon lamp predominantly by radiation, and then toward the solid collection area. The system further comprises a feeding system for the reactor, that is optionally heated by excess heat of the flash lamp illumination system and kept under an inert atmosphere, and a liquid and solid removal system avoiding the entry of air in the reactor.

In other example embodiments, a photonic processing system comprises a reactor including a chamber that receives waste feed material that comprises a hydrocarbon material and inorganic material, where the hydrocarbon material is present in the waste feed material in an amount of at least about 70% by weight of the waste feed material and the inorganic material comprises one or more metals. A photonic illumination or photolysis module irradiates the waste feed material within the chamber of the reactor to decompose the hydrocarbon material within the waste feed material into a gas and a carbonaceous solid material, and a mechanical movement unit moves the waste feed material within the chamber of the reactor to facilitate exposure of different portions of the waste feed material to irradiation within the chamber during system operation. In example embodiments of the system, the waste feed material comprises Automotive Shredder Residue (ASR) feed material.

In still further example embodiments, a method is provided of converting waste feed material into a product that comprises of providing the waste feed material into a chamber of a reactor, where the waste feed material comprising a hydrocarbon material and inorganic material, the hydrocarbon material is present in the waste feed material in an amount of at least about 70% by weight of the waste feed material, and the inorganic material comprises one or more metals or minerals. The waste feed material within the chamber is irradiated utilizing a photonic illumination or photolysis module to decompose the hydrocarbon material within the waste feed material into a gas and a carbonaceous solid material, and the waste feed material is moved within the chamber to facilitate exposure of different portions of the waste feed material within the chamber during the irradiating. In example embodiments of the method, the waste feed material comprises Automotive Shredder Residue (ASR) feed material.

By removing inorganic material from the waste material prior to feeding waste material to the reactor and subjecting the waste feed material to irradiation, the conversion of hydrocarbon material within the waste feed material to gas and carbonaceous solids is enhanced. Further, a majority of gas compounds (i.e., greater than 50% by weight of the gas product) generated by the irradiation of the waste feed material comprises hydrogen, carbon monoxide, methane, and carbon dioxide gases.

The above and still further features and advantages of the present invention will become apparent upon consideration of the following detailed description of specific embodiments thereof.

### BRIEF DESCRIPTION OF THE DRAWINGS

FIG. 1 schematically depicts an example embodiment of a ASR processing system including separation of constituents from ASR feed material and photonic processing of the ASR Hydrocarbon Fraction material within the system.

FIG. 2 schematically depicts a mechanical separation process before the material is sent for photonic processing as shown in FIG. 1.

FIGS. 3A and 3B depict a batch design of Photolysis reactor where photonic processing of the hydrocarbon fraction of ASR is achieved.

FIG. 4 depicts a continuous design of the reactor where photonic processing of the hydrocarbon fraction of ASR is achieved.

FIGS. 5A, 5B and 5C depict different configurations of a Photolysis reactor for continuous operation and utilizing different types of feed units of ASR material to the reactor.

Like reference numerals and/or like descriptions have been used to identify like elements throughout this disclosure.

### DETAILED DESCRIPTION

In the following detailed description, reference is made to the accompanying figures which form a part hereof wherein like numerals and/or like descriptions designate like parts throughout, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense, and the scope of embodiments is defined by the appended claims and their equivalents.

Aspects of the disclosure are disclosed in the accompanying description. Alternate embodiments of the present disclosure and their equivalents may be devised without parting from the spirit or scope of the present disclosure. It should be noted that any discussion herein regarding “one embodiment”, “an embodiment”, “an exemplary embodiment”, and the like indicate that the embodiment described may include a particular feature, structure, or characteristic, and that such particular feature, structure, or characteristic may not necessarily be included in every embodiment. In addition, references to the foregoing do not necessarily comprise a reference to the same embodiment. Finally, irrespective of whether it is explicitly described, one of ordinary skill in the art would readily appreciate that each of the particular features, structures, or characteristics of the given embodiments may be utilized in connection or combination with those of any other embodiment discussed herein.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The terms “comprising,” “including,” “having,” and the like, as used with respect to embodiments of the present disclosure, are synonymous.

In accordance with example embodiments as described herein, a system and process provide the photonic processing of Automotive Shredder Residue (ASR) and for the recovery of multiple valuable critical materials.

Flash light photonic surface treatment or flash light photonic curing is the process of rapidly raising the surface temperature of a material to at least 900° C., or over 950° C., or even over 1000° C., using high intensity flashing light. A flashing light source (electric arc lamp, also called flash tube) producing full spectrum white light can be used to photolyze, sinter and/or pyrolyze materials within a sample to be processed. The photonic surface treatment can be achieved using a photonic illumination or photolysis module that comprises one or more xenon flash lamps, one or more light emitting diode (LED) lamps, one or more ultraviolet (UV) lamps, one or more infrared (IR) lamps, concentrated solar radiation, and/or one or more mercury-xenon flash lamps.

In example embodiments described herein, a xenon (Xe) lamp can be utilized to create flashes of high intensity broad wavelength light for very short durations (e.g., less than 500 milliseconds, or even less than 200 milliseconds, or less than 100 milliseconds) over the ASR material for increasing the local surface temperature (due to selective absorption of light by metal precursors and other surrounding materials), causing the organic and/or other non-heat resistant materials such as plastics, binders, solvents, resins, etc. to heat up and evaporate and the remaining heat resistant materials like metal (nano) particles to sinter and form conductive paths, for example Ag and Cu. Since the temperature is raised locally by radiation, a wide range of transparent low glass transition temperature plastics like PET or PEN or even paper can be used as substrates. Flash light photonic surface treatment can further be used to modify the surface of materials. For example, it is possible to remove oxygen functionalities from graphene oxide to form conductive graphene patterns and form metal carbide from a metal oxide precursor in solid form. In addition, flash light photonic surface treatment can also be used to onset surface chemical reactions, such as nucleation and growth of metallic nanoparticles from precursor salt solutions or synthesis of Prussian Blue.

In accordance with the embodiments described herein, flash light photonic surface treatment can be used for hydrocarbon matter-to-energy conversion using one or more high-powered xenon flash lamps. Swift thermochemical reactions can convert hydrocarbon waste into combustible gases and porous conductive carbon, reducing conversion time to seconds. Using such photonic surface treatment can yield higher hydrogen gas and conductive carbon amounts compared to conventional pyrolysis, with an energy output similar to energy input/consumption by the process, where it is believed that a positive energy balance may further be possible in certain scenarios. There is further no need for expensive high-temperature ovens.

One feature of photonic processing of ASR is light absorption by the ASR hydrocarbon fraction feed in granular format in a wide temperature range and pressure in an inert atmosphere. The energy from the flash light, upon absorption by the ASR Hydrocarbon Fraction, causes a transient temperature rise of the material that drives the material decomposition reactions or photolysis. The inert atmosphere can be, e.g., argon (Ar), nitrogen (N₂), carbon dioxide (CO₂) or syngas. The flash light source used can be a xenon (Xe) lamp or a mercury-xenon (Hg—Xe) lamp, configured to emit sudden bursts of energy directed at the material. The ASR fractions can be treated in batches (e.g., a batch process) or in a continuous mode (continuous process).

In example embodiments, the system comprises a pre-processing system or unit comprising one or more separation modules that mechanically separates the ASR Hydrocarbon Fraction, mainly polymers, from metallic and mineral impurities using a combination of sieving, density, and magnetic separation. This ASR hydrocarbon fraction obtained from the pre-processing unit can then be subjected to photonic processing. The metallic and mineral fractions can also be processed in a further unit to produce sellable products with quality acceptable to downstream producers as recycled feedstock. The photonic processing reaction occurs in a reactor that performs photolysis of the ASR hydrocarbon fraction and breaks it down into its fundamental building blocks of hydrogen, carbon and methane, along with certain monomers and/or other simpler polymers.

The photolysis reactor comprises an insulated and sealed reaction chamber that can include a top or lid comprising a thick quartz glass that facilitates entry of flashing light to enter the chamber where the ASR hydrocarbon fraction is present in an inert gas atmosphere. The reaction chamber can also be fitted with a water circulation pipeline system to collect and dissipate the excess heat. The material can be moved along inside the reaction chamber mechanically and/or with gas flow.

A flashing light source can be situated just outside the reaction chamber quartz glass window, where the flashing light source, in operation, flashes electromagnetic radiation in the range between about 200 nm and about 600 nm with sufficient intensity that the material placed in the reaction chamber, being exposed to this radiation, instantly decomposes into gases and carbonaceous solids or residues.

A post-processing system or unit comprising one or more gas collection/cleaning modules, one or more separation modules and/or one or more heat recovery modules can be provided at a location downstream from the photolysis reactor so as to receive products from the reaction chamber for further processing.

While the embodiments described herein are in relation to processing of ASR material, it is noted that these embodiments are not limited to treatment of such waste from automotive vehicles. Alternatively, the embodiments described herein are also applicable to any other forms of waste that include hydrocarbon materials and inorganic materials (including metals and non-metals, such as silicon, silica or minerals), where such other forms of waste can include, without limitation, electronic waste (e.g., end-of-life computers, computer peripherals, domestic appliances, televisions, and other forms of electronic equipment), electronic waste that has undergone some pre-processing and any other form of scrap or hydrocarbon-rich demolition waste. Thus, the term “waste material” or “waste feed material”, as used herein, refers to both ASR material and other forms of waste material having the same or similar mixture of plastics and/or other hydrocarbon materials with metals and other forms of inorganic materials.

Example embodiments of the present invention are now described with reference to the drawings.

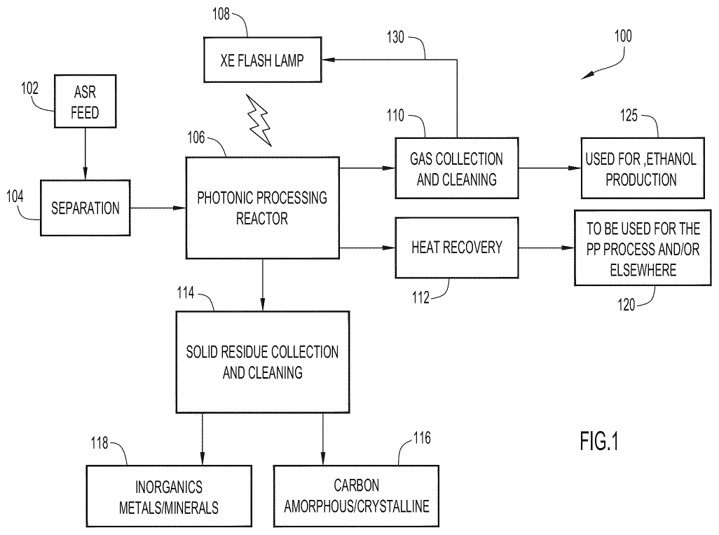

Referring to FIG. 1, a treatment system 100 for ASR material and/or any other types of waste material including hydrocarbon materials (e.g., plastics, polymers, resins, etc.) and inorganic materials (e.g., metals, silicon or silica and/or minerals) and corresponding process are schematically depicted to show initial input of ASR or other waste material, and various processing steps to form final products (metals, minerals, carbonaceous residues and gases). The system and process can be configured for collection of final products in batch or continuous modes. As used herein, the term “module” refers to a section or stage of the treatment system 100 that includes any suitable part(s) or equipment including mechanical, electrical and/or chemical components that facilitate processing of one or more types of materials (e.g. carbon and/or inorganic materials, such as metals and glass, silica, or other minerals) in the manner as described at such section or stage. The waste material is referred to herein in the embodiments as ASR material. But (as previously noted), the system and corresponding methods are also applicable for processing other forms of waste material.

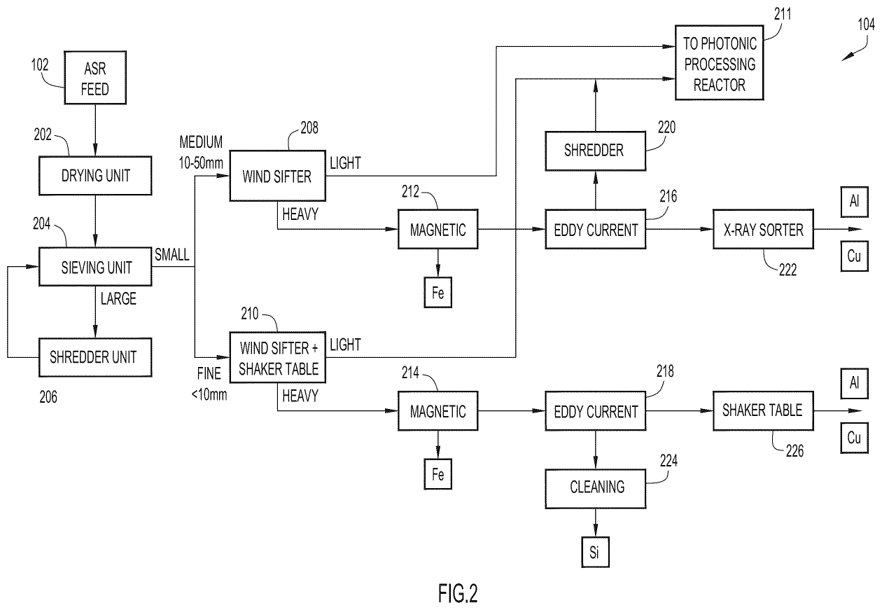

An ASR feed source module 102 provides ASR or mixed plastics/mixed polymers to a Separation module 104, where organic material or hydrocarbon fraction is separated from inorganic materials (e.g., glass, minerals, metals) (as shown in greater detail in FIG. 2, as described herein) using mechanical and/or other types of separation techniques. As used herein, the term “ASR” (also referred to as “ASR material”) refers to materials from end-of-life automotive vehicles that comprises hydrocarbon matter including plastics and/or other polymer materials and also inorganic matter including one or more metals (ferrous and/or non-ferrous metals), silica (glass), minerals, and any other waste materials associated with the vehicle. As previously described herein, end-of-life vehicle (ELV) treatment broadly includes 3 steps: 1. removal of polluting materials such as fluids, oil filters, batteries, catalytic converters, etc. from the vehicles, 2. removal of tires, rims, airbags, windscreens, etc. from the vehicles, and 3. shredding of car bulk to recover ferrous and non-ferrous metals. About 20-25% by weight of the ELV which remains as waste after industrial recycling, is defined as Automotive Shredder Residue (ASR) comprising mainly hydrocarbon materials (e.g., plastics and/or other polymer materials, including binders, solvents, resins, etc.), minerals and some residual metals not removed in the third step. ASR waste typically contains 10-25% metals, 10-25% minerals and 50-80% hydrocarbons. The systems and methods described herein are focused on the ASR material, i.e., the material from ELVs resulting or produced after performing all 3 previously noted steps. In particular, the ASR material that is processed via the system and methods described herein excludes any substantial amounts of rubber or other hydrocarbon material in automotive tires (since tires have been removed from the ELV prior to forming the ASR material). The ASR material that is formed after the third step/shredding of car bulk is typically about “hand-held” size or, e.g., less than 2 meters in greatest size or greatest dimension (e.g., typically less than 1 meter in greatest size or dimension, or preferably smaller than 0.5 meter in greatest size or dimension).

The ASR material can be reduced in size as a part of material pre-processing. As described in more detail herein (with regard to FIG. 2), the ASR material is first subject to one or more separation processes, via Separation module 104, which separate at least some of the metallic and inorganic materials from the ASR prior to the ASR being treated in the Photonic Processing Reactor 106. Thus, the system 100 and corresponding methods described herein facilitate more efficient processing of ASR by first removing as much metal, minerals and inorganic content as possible prior to photolytic processing of the ASR in the reactor 106.

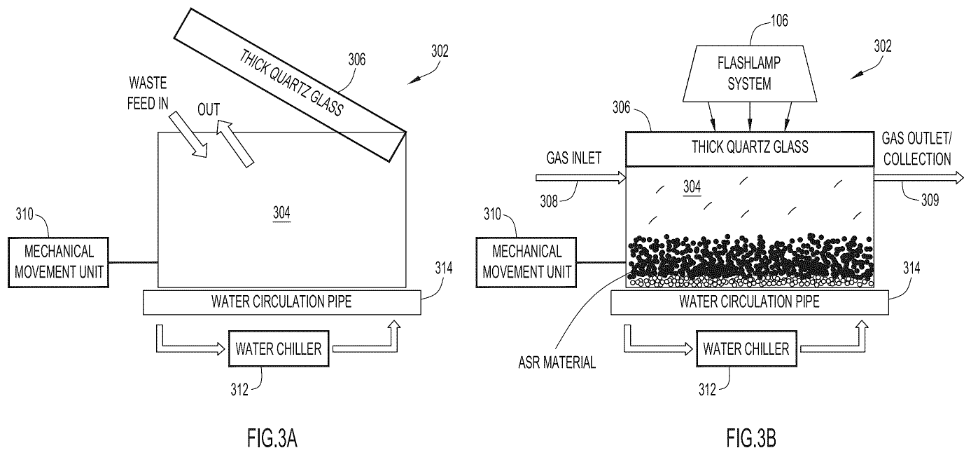

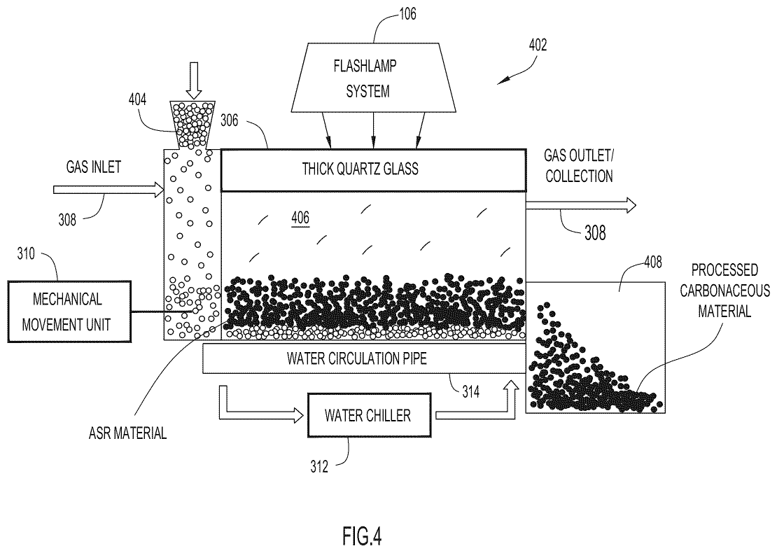

The hydrocarbon fraction of the ASR material (i.e., the ASR portion separated from metals and other inorganic materials in the Separation module 104) is transferred (e.g. manually) to a bottom part of a photonic processing (PP) reaction chamber within the reactor 106, where it is heated to at least 100° C., or at least 120° C., or at least 150° C., or more than 150° C. initially. In addition, the hydrocarbon fraction can be moved or shaken simultaneously while it is heated to move and spin, mix and/or overturn different portions of the feed material so as to continuously expose different portions of the ASR material within the chamber to the incoming flash light from a Xenon (Xe) Lamp module 108. An example embodiment of a reactor 106 which facilitates manual feed of the ASR Hydrocarbon Fraction for photonic processing in the reactor is depicted in FIGS. 3A and 3B (described in further detail herein). Alternatively, the ASR Hydrocarbon Fraction can be transferred to the bottom part of the reactor continuously using a mechanical movement unit, where it may be heated to more than 150° C. initially, and then semi-continuously or continuously transferred to the reaction chamber while avoiding oxygen entry, allowing unidirectional movement of the material under the incoming flash light. An example of a continuous delivery of ASR hydrocarbon fraction to the reactor 106 is depicted in FIG. 4 (described in further detail herein). In further non-limiting example embodiments, the ASR hydrocarbon fraction can be passed under the flash lamp continuously using a gas flow, where the gas flow controls the particle residence time and facilitates unidirectional movement of the carbon material under the incoming flash light.

The Xe flash lamp module 108 facilitates photonic processing of the ASR Hydrocarbon Fraction by subjecting the material to high-power flash light irradiation through a transparent quartz window. The photonic processing leads to rapid material decomposition or photolysis. The gases produced during this decomposition reaction are extracted through an exhaust gas Collection and Cleaning module 110, as shown in FIG. 1.

The Collection and Cleaning module 110 gathers and contains certain solid and/or liquid by-products that may be entrained within the gas exhaust exiting the chamber of the reactor 106. In a non-limiting example embodiment, a filter or any other suitable separator within the Collection and Cleaning module 110 can be provided to effectively separate solids and/or liquids entrained in the exhaust gas, where the exhaust gas passed through the filter while solids and/or liquids are captured thereon and collected within the module 110. In a further example embodiment, the high temperature gases collected from the Reactor 106 at the gas Collection and Cleaning module 110 can also be subjected to a cooling process to remove any low boiling-point liquids using condensation. The non-condensable fraction, which primarily consists of syngas (comprising light hydrocarbons), can be removed from module 110 and used within the system 100 and/or further processed (at 120). For example, the syngas can be further processed to produce ammonia, methanol, acetic acid, fuels, and/or other chemical compounds (at 125) in any conventional or other suitable manner. In another example, the syngas can be processed via any conventional or other suitable purification process to obtain components such as hydrogen or methane from the syngas. Further, a portion of the syngas (at gas line 130) can be utilized as a fuel source to power an electric power/heat generator, which in turn provides the necessary energy to operate the flash lamp module 108. Such an integrated setup allows for a self-sustaining and energy-efficient operation of the system 100.

The excess heat generated by the flash lamp module 108 can also be effectively recovered via a heat capture or heat recovery module 112. In a non-limiting example embodiment, a heat exchanger is provided that circulates a fluid to facilitate heat exchange from a portion of the reactor, and/or products emerging from the reactor, and the fluid circulating within the heat exchanger. A portion of this heat can be employed to warm the inlet of the photonic processing reactor 106, the inlet feed of ASR material into the module 106 and/or other modules of the system 100 depicted in FIG. 1. Alternatively, the recovered heat can be transferred and utilized in other suitable applications as needed.

Solid residues emerging from (e.g., from a lower end of) the Reactor 106 can be collected by the Solid Residue Collection and Cleaning module 114. The solid residues include hydrocarbon or carbonaceous solids (e.g., elemental carbon such as ash, porous carbon, graphene, graphite, or carbon black.) and inorganic solids, including metals and minerals. Any residual inorganic material, including metallic and mineral contents, can be extracted from the solids within the module 114 in any suitable manner. Such extraction can be performed either mechanically by sieving followed by filtering, washing, leaching, sonication or by other electro-mechanical or chemical equipment and methods. For example, carbonaceous solids can be washed to remove oils and minor inorganic content, where the separated materials can be collected as elemental carbon in collector 116 (amorphous and/or crystalline) and inorganics in collector 118 (metals and/or minerals) for further processing.

Referring to FIG. 2, the Separation module 104 is the first part of the process for separation and recovery of valuable metals and minerals from the waste ASR and mixed plastic/hydrocarbon material feed. The module 104 receives ASR feed from module 102 and directs the ASR feed to a drying unit 202 that removes moisture content that may be present in the ASR material. Next, the dried ASR feed is directed to a sieving unit 204, where the sieving unit 204 separates large fractions (e.g. materials greater than about 50 mm in size, e.g., as determined by diameter or largest cross-sectional dimension) from small fractions (e.g. materials no greater than about 50 mm in size, as determined by diameter or largest cross-sectional dimension). The sieving unit can include any number (one or more) of filters having one or more suitable pore sizes to facilitate separation of larger ASR fragments or fractions from smaller ASR fragments or fractions. A shredder unit 206 can also be provided to receive the larger ASR fractions from the sieving unit 204 and break the larger fractions into smaller fractions to be delivered back to the sieving unit 204 (as shown in FIG. 2).

The sieving unit 204 can further separate the small ASR fractions into medium size fractions (e.g., materials from about 10 mm to about 50 mm in size) and fine fractions (e.g., materials less than about 10 mm in size) so as to remove heavier inorganic materials from such small fractions prior to photonic processing of the small fractions. In the embodiment depicted in FIG. 2, medium fractions are delivered to a wind sifter 208 which separates light fractions (substantially hydrocarbon matter, i.e., a majority or greater than 50% by weight of the light fractions is hydrocarbon matter) from heavier fractions (substantially inorganic matter, i.e., a majority or greater than 50% by weight of the heavier fractions is inorganic matter), where the light fractions are also typically smaller in size (e.g. no greater than about 10 mm in size) in relation to the heavier fractions. The wind sifter separates materials by density and operates by subjecting the material to a flow of air including the material in a chamber (e.g., a vertical airflow within the chamber) at a suitable flow rate that facilitates capture of lighter materials within the air stream and separation, via the air stream, from heavier materials that are not captured/moved within the air stream. Similarly, the fine fractions are delivered to a wind sifter/shaker table 210 to separate light (substantially hydrocarbon) fractions from heavier (substantially inorganic) fractions. The shaker table portion provides a further separation feature in addition to the wind sifter that separates smaller, particle size materials based upon specific gravity, density and shape of such materials.

The light fractions from each of the wind sifter 208 and wind sifter and shaker table 210 are delivered (at 211) to the photonic processing reactor 106.

As shown in FIG. 2, each heavier ASR fraction from the wind sifter 208 and wind sifter and/or shaker table 210 is delivered to a respective magnetic separation unit 212, 214, where unit 212 processes medium-sized materials (e.g., about 10 mm to about 50 mm in size) while unit 214 processes fine sized materials (e.g., less than about 10 mm in size). The magnetic separation units 212, 214 each separates ferrous materials (e.g., iron, steel or other ferrous alloys) from non-ferrous metals (e.g., aluminum, copper, etc.) and/or other non-ferrous materials (e.g., silica, minerals, etc.) via one or a plurality of magnets within the units 212, 214 that attract and prevent the ferrous materials from leaving these units while the non-ferrous materials that are not attracted by the magnet(s) pass through the units. The non-ferrous metals/materials which have been separated from the ferrous materials within each magnetic unit 212, 214 are delivered to a respective eddy current unit 216, 218. The eddy current unit 216 utilizes a rotating magnetic unit with alternating polarity that generates alternating magnetic fields or “eddy currents” within the unit to separate non-ferrous metals, e.g., copper (Cu) and aluminum (Al), from non-metallic materials (e.g., hydrocarbon materials captured within the heavy fractions). The non-metallic materials separated in eddy current unit 216 are shredded in another shredder unit 220 to further reduce the size of the medium size materials (e.g., further shredding to a size that is no greater than about 10 mm), where the shredded non-metallic materials are then delivered (via 211) to the Photonic Processing Reactor 106. The non-ferrous metals separated from non-metallic materials in the eddy current unit 216 are provided to an X-ray sorter unit 222 which facilitates recovery of Cu and Al (e.g., facilitating separation of Cu from Al).

The eddy current unit 218 separates fine sized (e.g., less than about 10 mm in size) materials into non-ferrous metals (e.g. Cu and Al) and non-metallic materials (e.g., substantially silica, other minerals, etc.). The separated non-metallic materials can be delivered from unit 218 to a cleaning unit 224 to facilitate recovery of silica and other minerals. The fine non-ferrous metals can be delivered from unit 218 to a shaker table 226 to facilitate separation of non-ferrous metals (e.g., separation of Cu from Al).

The Separation module 104 can further include any other suitable conventional or other types of mechanical and/or other (e.g., electrical or chemical) units to facilitate separation of materials into various sizes as well as separation of non-metallic materials from metallic materials and further separation of ferrous metals from non-ferrous metals and minerals, and still further separation of two or more non-ferrous metals from other non-ferrous metals or minerals in any material stream to be processed by the system.

Thus, the Separation module 104 effectively removes a substantial portion of non-hydrocarbon material (ferrous and non-ferrous metals, minerals, silica, etc.) from the ASR material prior to delivery to the Photonic Processing reactor 106. This maximizes the effectiveness of the reactor 106 in photolysis of hydrocarbon material within the ASR entering the chamber of the reactor. In particular, the Separation module 104 can effectively remove non-hydrocarbon matter from the ASR material (or other waste material) such that the processed ASR material (or other waste material) entering the reactor 106 has a hydrocarbon content of at least 70% by weight of the ASR material (e.g., about 70% to about 95% by weight of the ASR material to be processed within the PP reactor is hydrocarbon matter). With this pre-processing, substantial amounts of metals and minerals can be removed from the input ASR, and residual ASR Hydrocarbon Fraction could have 70-95% hydrocarbon content. The inorganic material within the ASR material (and which makes up a minority, or less than 50% by weight of the ASR material) can include metals (ferrous and/or non-ferrous), minerals and/or silica. In addition, the ASR material that is processed via the system and methods described herein does not include any substantial amount of rubber from tires (since, as previously noted, tires have been removed from the ELV prior to obtaining the ASR material).

Referring to FIGS. 3A and 3B, an example embodiment of a Photonic Processor (PP) reactor 106 is depicted as a batch reactor in which ASR material is fed into and then maintained within the reactor during the batch process (where the ASR material is irradiated within the reactor during the batch process). The module 106 is depicted in FIGS. 3A and 3B as a reactor 302 that includes a thermal decomposition reaction chamber 304 with a thick upper window or wall 302 that is transparent or translucent to permit light to pass through the wall 302. The upper wall 302 comprises a thick quartz glass window 306 that can be moved (e.g., pivoted) from an open upper end of the reactor 302 to facilitate placement of the ASR material in a set amount (e.g., via a set weight) manually or mechanically into the reaction chamber 304 (as shown in FIG. 3A). The chamber 304 and flash lamp module 106 are configured to facilitate chamber 406 or photonic decomposition of hydrocarbon material within the chamber 304 via flash light (operation is shown in FIG. 3B). The glass window 306 is preferably heat resistant to withstand high temperatures within the chamber 304 that result from operation of the reactor 302. The reactor 302 is further configured to facilitate photolytic reaction within the chamber 304 in an inert atmosphere. Thus, the reactor 302 is configured to provide the chamber 304 with an inert atmosphere comprising an inert gas supply, such as providing suitable piping including inlet 308 and outlet 309 (FIG. 3B) to facilitate pumping of an inert gas (e.g., nitrogen, argon, carbon dioxide and/or syngas) into the chamber 304 to displace oxygen therein prior to initiating the photonic decomposition operations. The reactor 302 can further be configured to maintain the chamber 304 at a predetermined pressure and/or temperature during operations, so as to facilitate suitable photonic conversion reactions of the hydrocarbon materials placed within the chamber 304. Further still, the reactor design can include a chamber configured for photonic processing of feed materials and a source of electromagnetic energy positioned externally and parallel to the chamber. This design may be configured in such a way that the irradiation system emits electromagnetic radiation directly toward the feed material placed inside the chamber through a window on the chamber's wall.

The source of electromagnetic energy can utilize a xenon flash lamp or a mercury-xenon flash lamp, or any other electromagnetic radiation source capable of emitting photons within a broad range of frequencies, preferably resembling the frequency range found in sunlight. The frequencies of the photons emitted fall within the range of 200 nm to 600 nm.

The location of the light source outside the chamber 304 ensures that photons with sufficient energy intensity arrive at the ASR material inside the chamber. This intensity is carefully calibrated to induce a photonic decomposition in at least a portion of the material. By employing this configuration, and in particular in combination with separating a large portion of the non-hydrocarbon material from the ASR material prior to photonic processing of the ASR material, an efficient and controlled decomposition of the ASR material within the PP reactor is achieved, thus providing significant advantages over other conventional techniques for ASR decomposition and processing.

The system has an inlet through which the material may be provided, which (as previously noted for FIGS. 3A and 3B) can be the transparent window 306 being moved (e.g. pivoted) away from one or more side walls of the reactor 302 to provide an opening to the chamber 304. After ASR material has been provided within the chamber 304 (as shown FIG. 3B), the window 306 can be moved back into place along the reactor so as to provide a fluid/gas tight seal to facilitate generation of an inert gas environment within the chamber 304 (e.g., by pumping inert gas through the chamber via gas inlet and outlet 308 as shown in FIG. 3B). The ASR material can further be moved, mixed and/or turned within the chamber 304 utilizing a mechanical movement unit 310 (e.g., a screw extruder or other mechanical mechanism) to facilitate maximum exposure of all particles or components of the ASR material during photonic processing and ASR decomposition operations. Thus, the reactor is suitably designed for maximum exposure of the ASR material and sufficient intensity of the photons striking the ASR material within the chamber 304 to facilitate suitable decomposition and conversion of hydrocarbons to elemental carbon or simpler hydrocarbon forms when the light source is activated.

A heat transfer system can also be provided to provide cooling of the flash lamp module 106, the reaction chamber 304, the mechanical movement unit 310 and/or any combination of these components. In the example embodiments, the heat transfer system comprises a water chiller 312 to circulate chilled water, via a water circulation pipe 314, along one or more portions of the reactor 302 (e.g., along a lower wall that is adjacent ASR material being processed within the chamber 304). The chilled water can be provided to control temperature of the reactor 302 during operations. The water circulation pipe 314 can further be provided along any portions of the reactor 302, including at or near the flash lamp module 106, along one or more sides of the reactor 302 and/or at or near portions of the mechanical movement unit 310. The water circulation via pipe 314 can also be part of the heat recovery module 112 (as shown in FIG. 1), where the heat transferred from water used to cool portions of the reactor can be applied to other portions of the system (e.g., used to pre-heat ASR material prior to the inlet of the reactor).

Another reactor embodiment that can be used with system 100 is depicted in FIG. 4. In particular, a continuous reactor 402 is depicted in which ASR material is provided in a continuous feed via a hopper and inlet chamber or other inlet source 404 into the reaction chamber 406 for processing. A conveyor belt grate or rotary screw system and/or any other suitable transport arrangement can be configured to convey the ASR material from one or more components of the Separation module 104 to the reaction chamber 406, as well as to position the ASR material in an appropriate place within the chamber 406 to take place when the flash lamp module 106 activated. Consequently, the light source and the mechanical moving unit are mutually arranged within the reactor 402 such that the photons arrive at the ASR material within the chamber 406 with sufficient intensity similar to that previously described herein for chamber 304 of reactor 302. In this embodiment, the gas inlet 308 that delivers inert gas to the chamber 406 can also be provided at the inlet source 404 to assist in delivering ASR material into the chamber 406. As shown in the continuous reactor 402 of FIG. 4, processed carbonaceous material flows from an exit or outlet of the chamber 406 (e.g., via operation of the mechanical movement unit 312, which can move material through the chamber 406 between inlet and outlet) and to a collection unit 408. The reactor design can further be configured to ensure a suitable residence time of the ASR material within the chamber 406 to facilitate a suitable decomposition and conversion of ASR material to carbonaceous material.

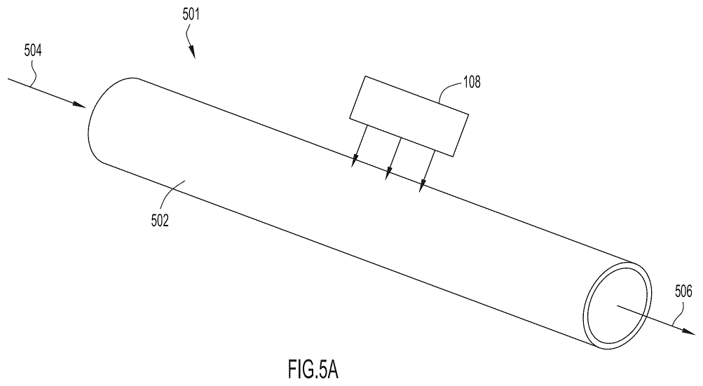

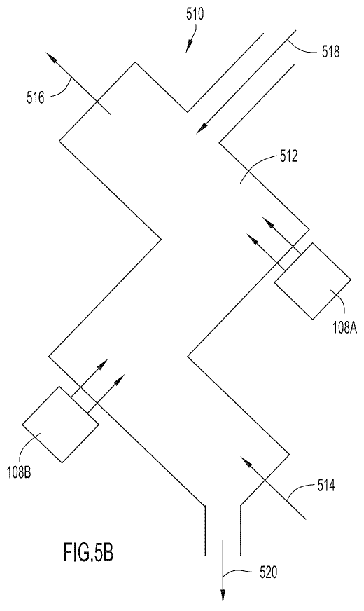

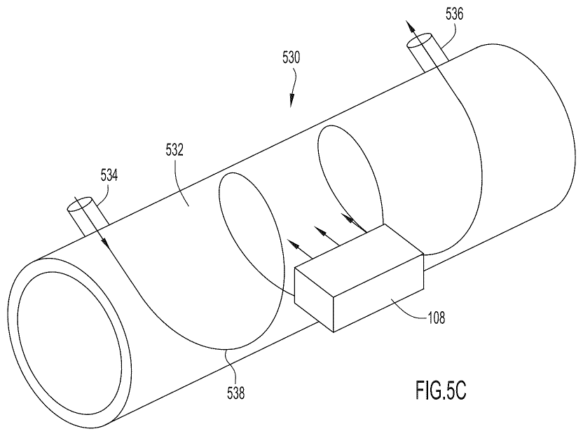

Other example embodiments of reactors suitable for use in system 1 are depicted in FIGS. 5A-5C.

For example, a reactor configuration can be configured such that ASR material can be delivered into the reaction chamber of the reactor with the assistance of a gas flow (e.g., inert gas flow), such as a vortex gas flow, and/or via a gravity-assisted flow through an opening at an inlet of the reactor suitably distanced from the quartz glass window (so as to avoid soot deposition along the window). This is depicted in the examples of FIGS. 5A and 5B. In such reactor designs, the reaction chamber can have a suitable pitch along the horizontal in which the reactor is situated to facilitate or assist in flow of ASR material through the chamber between inlet and outlet while ensuring a suitable residence time of the material within the chamber so that suitable conversion of ASR material to carbonaceous material occurs. Such reactor configurations can further have elongated (e.g., cylindrical) dimensions to facilitate continuous flow and suitable residence times of the material flowing within the reactor. In addition, such configurations provide feeding of the ASR feed material within the reactor so as to move, spin, mix and/or overturn the ASR feed material to ensure that different portions of the ASR feed material are exposed to photonic energy and irradiation during operation.

Referring to FIG. 5A, a tubular reactor 501 comprises a cylindrical chamber 502 with an inlet 504 and outlet 506 and the lamp module 108 being disposed near a window along the chamber 502 (e.g., at a central location or midpoint of the lengthwise dimension of the chamber). The inlet 504 can deliver an inert gas along with the ASR material, and the cylindrical chamber 502 can optionally be tilted or inclined at a suitable incline angle in a downward orientation from inlet 504 to outlet 506 to assist in continuous flow of ASR material through the reactor 501. The reactor 501 can also be inclined with an adjustable tilt angle with the ASR material inlet being at a greater elevation than the outlet from the reaction chamber, where the tilt angle is selectively adjusted to modify and/or control (e.g., in combination with pressure and flow rate of inert gas through the reaction chamber) the flow and residence time of the ASR material through the reaction chamber.

In the embodiment of FIG. 5B, the reactor 510 includes a chamber 512 having a tortuous or zig-zag pathway for flow of ASR material and inert gas flow through the chamber 512. In particular, the chamber 512 includes an inert gas inlet 514 and an inert gas outlet 516. Located proximate the inert gas outlet 516 is an ASR material inlet 518, and an ASR material outlet 520 located proximate the inert gas inlet 514. This configuration results in an opposing or countercurrent flow between the inert gas and ASR material flowing through the chamber 512. The ASR material inlet 518 can be provided at a vertically higher level along the chamber in relation to the ASR material outlet 520, so that gravity can assist in directing the ASR material through the chamber between inlet and outlet. The opposing or countercurrent inert gas flow can be directed at a suitable pressure and flow rate so as to reduce the flow rate of ASR material flowing through the chamber 512 and thus ensure a suitable residence time for the flowing ASR material within the reactor 510. The zig-zag path of the chamber 512 includes a first turn (e.g., 90° turn) and a second turn (e.g., 90° turn) between the inert gas and ASR material inlets and outlets. A plurality of lamps 108 can also be provided along the reactor 510 with corresponding windows within the reactor wall to allow irradiation of ASR material within the chamber 512 via operation of the lamps. A first lamp 108A can be provided at or near the first turn of the chamber 512, while a second lamp 108B can be provided at or near the second turn of the chamber.

The reactor 530 of FIG. 5C includes a generally cylindrical chamber 532 with inlet 534 to receive ASR material and inert gas and an outlet 536 from which the processed ASR material (including elemental carbon and/or other carbonaceous compounds) and inert gas emerge from the chamber. The inlet 534 and outlet 536 are disposed along the side of the cylindrically shaped reactor so that the flows are injected radially within the reaction chamber 532 to provide a vortex flow of ASR material with inert gas (represented by the helical path 538) in the chamber. One or more lamps 108 are also disposed along sidewall portions (with corresponding windows along the sidewall portions) of the reactor to facilitate irradiation of the ASR material flowing along the vortex path within the chamber 532. For example, a plurality of lamps 108 can be provided radially in relation to the chamber 532 so as to irradiate at different locations and different radial directions along the chamber.

The photonic processing parameters of the flash lamp module and corresponding dimensions and other parameters of the reactor are suitably configured to ensure desired photonic processing and conversion of ASR material to carbonaceous material within the reactor for a particular process. In the example embodiments described herein, electromagnetic radiation emitted by a xenon lamp is provided to perform photonic processing of the carbon fraction derived from ASR material provided to the reactor. The electric pulses required to generate the radiation can be set at a voltage of 200 Volts and a frequency of 60 Hz. Each pulse has a duration of at least about 10 milliseconds (e.g., about 5 milliseconds), and the entire photonic process can be completed within a very short time period, e.g., less than about 30 seconds (or about 14 seconds). In such embodiments, it is not necessary to pre-heat the ASR material prior to treatment within the reaction chamber.

In other example embodiments, the ASR material can include pre-heating before subjecting it to photonic processing. Depending on the desired flash intensity, the irradiation conditions can be adjusted to provide photonic energy within the ranges of 200-325 Volts, 10-120 Hz frequency, and 0.5-5 milliseconds pulse width, using a 16 kW machine. These parameters may vary further when employing a higher power irradiation system.

Following the photonic processing of the ASR material within the reactor, the resulting carbon, metallic, and mineral particles can be mechanically separated (as depicted in FIG. 1). In specific and non-limiting example embodiments, the photonic processing of the ASR material sourced from the recycling of end-of-life vehicles (ELVs), takes place using 200V electric voltage pulses at a frequency of 60 Hz, with each pulse lasting 5 ms (milliseconds) during 14 seconds of flash light irradiation. The process can be carried out on 500-1000 mg of hydrocarbon fraction powder, with the feed quantity dependent on the reactor size, under an argon flow within an oxygen-free atmosphere. A majority of gas compounds (i.e., greater than 50% by weight of the gas product) generated by irradiation of the ASR feed material comprises hydrogen, carbon monoxide, methane, and carbon dioxide gases.

In specific examples related to the processing of waste tires under an argon atmosphere, performed with the same irradiation conditions as described herein, additional gaseous by-products such as hydrogen, methane, ethylene, alkenes, and isoprene may be generated. The photonic processing can be conducted on 500 mg of the carbon fraction, using a 20 mL/minute argon flow in an oxygen-free atmosphere. In contrast, the primary gases produced when utilizing the system and methods as described herein include hydrogen, methane, carbon dioxide, and carbon monoxide, with negligible presence of nitrogen dioxide and sulfur dioxide. This is due, at least in part, to separation of non-hydrocarbon materials from the ASR material such that greater than 50% by weight of the ASR material (i.e., a majority of the ASR material) is hydrocarbon (i.e., hydrocarbon based) matter.

The residual carbon produced from the photonic processing using the system and embodiments as described herein comprises elemental carbon (e.g., carbon black, graphite, graphene, and/or microporous carbon) along with some residual metals and minerals. The rapid photonic processing from strong flash light irradiation (e.g., about 14 seconds) may lead to a high degree of graphite defects and the generation of microporous carbon. In certain embodiments, it is possible to achieve a complete conversion of the ASR material input into the reactor into carbon particles and inorganic matter.

Compared with conventional or known incineration and other thermal conversion systems using ovens and thermal reactors to decompose ASR material and mixed plastic waste, the system according to embodiments described herein relies on a high-power and high-intensity light system to deliver energy directly to the ASR material.

In conventional ovens or reactors, the ASR material or mixed plastic waste powder is heated either by heat conduction from the hot oven or from the surrounding gas. As is known, ASR material consists of a highly heterogeneous mixture comprising diverse fractions, including plastics, metals, fibers, and substantial amounts of sand and dirt and its incineration results in high ash content, generation of toxic gases such as dioxins, furans, oxides of sulfur, NOx, HCl, etc. along with high concentrations of leachable metals in the ash such as Zn, Pb, Ni, Cd, Sb, As, Sn etc. During the process of thermal pyrolysis, the waste undergoes an indirect heating mechanism, and the gradual rate of heating results in several phase transfers before transforming into gases and carbonaceous solids. For example, the material initially releases volatile components, subsequently converts into oils, and finally, at higher temperatures, syngas is generated. However, it is essential to note that the low heat conductivity exhibited by ASR material or mixed plastic waste is not conducive to facilitating these pyrolysis reactions effectively.

In accordance with the systems and methods described herein, the decomposition of the ASR hydrocarbon fraction primarily occurs through radiation, in which photons are absorbed to elevate both vibrational and electronic energy and cause disruption of covalent bonds, causing radical reactions. A xenon flash lamp, when irradiating a metal plate, can rapidly raise the temperature well beyond 1000° C. in less than one second.

For the hydrocarbon fraction from ASR material, the intense white light emitted by the xenon flash lamp is absorbed by the material. Consequently, the reaction energy is predominantly supplied through radiation rather than heat conduction, resulting in swift material decomposition. As a consequence, the main products resulting from the systems and methods as described herein are hydrogen-rich gases (syngas) and solid carbonaceous particles containing the residual minerals and metallics—the predominant constituent of polymers. In comparison to conventional thermal pyrolysis methods, negligible amounts of oil or tar are produced during photonic processing. It is believed that a direct vaporization and conversion of the volatiles and hydrocarbon matter occur at such a high intensity light exposure and absorption.

In addition, the systems and corresponding methods described herein optimize the heat generated with the light illumination system, principally to use it in further steps such as those depicted in FIG. 1 or elsewhere during the process, if needed.

Reaching high temperatures in a very short time causes immediate breakdown of long-chain molecules and leaves behind solid ash containing conductive carbon, that after separation and cleaning can find its application as reinforcements in tires, additives in inks and pigments industry as well as for conductive electrodes for battery applications.

The embodiments described herein further have demonstrated remarkable efficacy in generating hydrogen and carbon from ASR material and other such waste, aligning well with the principles of a circular economy. The embodiments described herein surpass conventional thermal pyrolysis in hydrogen production. The increased hydrogen production contributes to the economic efficiency of this system and methods described herein, thus providing a promising solution for sustainable resource utilization.

Example—Photonic Processing of the Carbon Fraction Derived from ASR Material

Utilizing a system and corresponding process as described herein and depicted in FIG. 1, an ASR material was processed and analyzed. The elemental composition of pre-treated ASR carbon fraction from the ASR material was determined by elemental analysis and Energy Dispersive X-ray Fluorescence (EDXRF), and the results obtained are summarized in Table 1 as follows:

TABLE 1
Elemental composition of pre-treated
carbon fraction derived from ASR.

| Element | Mass % |
|---|---|
| C | 27.2 |
| H | 3.6 |
| N | 1.4 |
| S | 1.5 |
| O | 21.4 |
| Inorganic | 44.9 |
| matter* | |

*Calculated by difference.

This confirms that carbon and oxygen are the major elements among the hydrocarbon content with 48.6 wt %, while N, S and H are 6.5 wt %, the remaining 44.9 wt % is attributed to the inorganic matter from fillers, metals and minerals. In addition, the hydrocarbon material comprised greater than 50% by weight of the ASR material after processing via separation techniques such as described and depicted in FIG. 2 for the Separation module 104.

Photonic processing was conducted on a 500 mg sample of the carbon fraction derived from ASR material (<1 μm sized particulate) utilizing a batch reactor similar to that depicted in FIGS. 3A and 3B. The ASR material was initially spread as a uniform film onto a rectangular reactor and then sealed with a quartz window of 3 mm thickness and O-ring placed out of the flash light exposition area. Next, before the flash light irradiation, a moderate flow of inert gas (argon) was circulated for 2 minutes to remove the oxygen. Finally, the material was exposed to multiple flashes of light from a xenon flash lamp pulsed with electric pulses having a voltage of 200 V at a frequency of 60 Hz, the pulse duration being 5 milliseconds over a period of 14 seconds. This produced gases such as H₂, CH₄, CO₂, CO and other hydrocarbons corresponding to 93% of the total weight of the produced gases, as shown in Table 2:

TABLE 2
Total solid content generated by photonic processing
of ASR powder after the experiment.

| Weight before | Weight after | % Total solid |
|---|---|---|
| photo-pyrolysis | photo-pyrolysis | (carbonized |
| (mg) | (mg) | matter) |
| 500 | 294 | 58.8 |

A solid fraction of 60 wt % corresponding to 22 wt % of organics and 78 wt % of inorganics (metals and minerals) was obtained. A high temperature (about 950° C.) was reached in a very short time-less than 14 seconds. Moreover, in the example embodiment, the surface area of the carbon was enhanced 5 times that of the as received ASR material, i.e., from 3 to 15 m²/g.

Thus, embodiments as described herein comprise a photonic processing system for ASR or mixed plastic waste powder from end-of-life vehicles, or for processing other types of waste materials including a mixture of hydrocarbon material and inorganic material, that comprises:
a. a reaction chamber having an inlet for the carbon fraction feed material, a solids removal outlet, a gas stream removal outlet and a heat resistant transparent window;
b. a mechanical moving system to move and expose the feed material under the heat resistant transparent window through which illumination of the feed material occurs to transfer energy from the xenon lamp predominantly by radiation rather than by conduction;
c. a mechanical moving system to pass, move and expose the feed material toward and under the heat resistant transparent window through which illumination of the feed material occurs to transfer energy from xenon lamp predominantly by radiation rather than by conduction, and then toward the solid collection area;
d. a feeding system for the reactor, that may optionally be heated by the excess heat of the flash lamp illumination system and kept under an inert atmosphere; and
e. a liquid and solid removal system avoiding the entry of air in the reactor.

The photonic processing system can further comprise a feeding mechanism for the feed material into the inlet of the reaction chamber, along with a gas management system to keep the feed material under an inert atmosphere and optionally with a heating system to raise the feed material temperatures to above 150° C.

The photonic processing system can further comprise a flash lamp system to illuminate the ASR or mixed plastic waste powder removed from end-of-life vehicles through the heat resistant transparent window.

The photonic processing system can further comprise a heat transfer system to ensure the cooling of the flash lamp illumination system, the cooling of the reaction chamber and optionally the mechanism for the heating of the feed material.

The photonic processing system can further comprise a feed material mechanical movement system, that can be a grate, a rake, a conveyer, a wheel, a disk, a rotary screw or any other suitable structure to move and expose the feed material inside the reaction chamber to an illumination area close to the heat resistant transparent window to be converted.

The photonic processing system can further comprise a feed material mechanical movement system, that can be a grate, a rake, a conveyer, a wheel, a disk, a rotary screw or any other suitable structure to convey the feed material from the inlet of the reaction chamber to an illumination area close to the heat resistant transparent window to be converted.

The photonic processing system can further comprise a solids removal system, along with a liquids removal system, with airlocks avoiding air entry in the reaction chamber.

The photonic processing system can further comprise a separation system for the solids and liquids to recover the oil phase (if any), the carbon materials and the residual metals and minerals.

The photonic processing system can be configured such that the flash lamp illumination system includes a xenon flash lamp or a mercury-xenon flash lamp.

The photonic processing system can be configured such that the mechanical conveying system can comprise a grate, a rake, a conveyer, a wheel, a disk, a gas flow, a rotary screw or any other suitable structure that facilitates rolling the feed material to be spun inside the reaction chamber directly under the heat resistant transparent window.

The photonic processing system can be configured such that the mechanical conveying system can be a grate, a rake, a conveyer, a wheel, a disk, a gas flow, a rotary screw, or any other suitable structure that facilitates carrying the feed material in front of the heat resistant transparent window and toward the solid collection unit.

The photonic processing system can be configured such that the mechanical conveying system can be a grate, a rake, a conveyer, a wheel, a disk, a gas flow, a rotary screw with angled blades or any other suitable structure that facilitates carrying the feed material to in front of the heat resistant transparent window and toward the solid collection unit.

In further example embodiments, a photonic processing system comprises a reactor including a chamber that receives waste feed material that comprises a hydrocarbon material and an inorganic material, where the hydrocarbon material is present in the waste feed material in an amount of at least 70% by weight of the waste feed material and the inorganic material comprises one or more metals. A photonic illumination or photolysis module irradiates the waste feed material within the chamber of the reactor to decompose the hydrocarbon material within the waste feed material into a gas and a carbonaceous solid material, and a mechanical movement unit moves the waste feed material within the chamber of the reactor to facilitate exposure of different portions of the waste feed material to irradiation within the chamber during system operation.

The photonic illumination or photolysis module can comprise one or more xenon flash lamps, one or more light emitting diode (LED) lamps, one or more ultraviolet (UV) lamps, one or more infrared (IR) lamps, concentrated solar radiation, or one or more mercury-xenon flash lamps. The photonic illumination or photolysis module can further provide photonic energy within the chamber at voltage from 200V to 325V, a frequency from 10 Hz to 120 Hz, and a pulse width from 0.5 milliseconds to 5 milliseconds.

During system operation, the photonic illumination or photolysis module can provide photonic energy in pulses within the chamber so as to raise exposed surface portions of the waste feed material within the chamber to about 900° C. to facilitate decomposition of the waste feed material into gas and solids.

A solid collection module can be provided that receives the solid material emerging from the reactor and separates the solid material into the carbonaceous solid material and an inorganic solid material.

A gas line can be provided that receives syngas from the reactor and provides energy from the syngas for operation of the reactor or for other downstream use or chemical and/or fuel production.

An inert gas supply can provide an inert gas to the chamber of the reactor to establish an inert gas atmosphere within the chamber during system operation. In addition, a feeding unit can be provided that heats the waste feed material to over room temperature and provides the heated waste feed material to the chamber of the reactor.

A separation module can be provided that processes waste material to form the waste feed material delivered to the reactor, where the separation module comprises a sieving unit to separate larger waste material fractions from smaller waste material fractions based upon fraction size, and one or more sifter units to separate the smaller waste material fractions into light components comprising a majority of hydrocarbon material and heavy components comprising a majority of inorganic material. The light components can be provided as waste feed material from the separation module to an inlet of the chamber of the reactor. The smaller waste material fractions can be no greater than 50 mm in size. The sieving unit can further separate the smaller waste material fractions into medium waste material fractions having sizes ranging from 10 mm to 50 mm and fine waste material fractions having sizes less than 10 mm, and the one or more sifter units can further comprise a first sifter unit that separates the medium waste material fractions into light components and heavy components, and a second sifter unit that includes a shaker table to separate the fine waste material fractions into light components and heavy components.

One or more further separation units can be provided that separate the heavy components into metallic fractions and non-metallic fractions and further separate the metallic fractions into ferrous metallic fractions and non-ferrous metallic fractions.

In example embodiments for the system, the waste feed material can comprise Automotive Shredder Residue (ASR) feed material.

In other example embodiments, a method is provided for converting waste feed material into a product that comprises a gas and a solid, the method comprising providing the waste feed material into a chamber of a reactor, wherein the waste feed material comprises a hydrocarbon material and an inorganic material, the hydrocarbon material is present in the waste feed material in an amount of greater than 50% by weight of the waste feed material, and the inorganic material comprises one or more metals and/or minerals, irradiating the waste feed material within the chamber utilizing a photonic illumination or photolysis module to decompose the hydrocarbon material within the waste feed material into a gas and a carbonaceous solid material, and moving the waste feed material within the chamber to facilitate exposure of different portions of the waste feed material within the chamber during the irradiating.

The method can further comprise receiving solid material emerging from the reactor, and separating the solid material into the carbonaceous solid material and an inorganic solid material.

Inorganic material can be removed from waste material to form the waste feed material that is provided to the chamber of the reactor. The removing inorganic material from waste material can comprise separating larger waste material fractions from smaller waste material fractions based upon fraction size, and separating the smaller waste material fractions into light components comprising a majority of hydrocarbon material and heavy components comprising a majority of inorganic material. The light components can be provided as waste feed material to an inlet of the chamber of the reactor. The smaller waste material fractions can be no greater than 50 mm in size. The separating the smaller waste material fractions into light components can further comprise separating the smaller waste material fractions into medium waste material fractions having sizes ranging from 10 mm to 50 mm and fine waste material fractions having sizes less than 10 mm, and the one or more sifter units can further comprise separating the medium waste material fractions to form the light components and heavy components. The fine waste material fractions can be separated to form the light components and heavy components. In addition, the heavy components can be separated into metallic fractions and non-metallic fractions, and the metallic fractions can be separated into ferrous metallic fractions and non-ferrous metallic fractions.

In the method, the photonic illumination or photolysis module can provide photonic energy within the chamber at voltage from 200V to 325V, a frequency from 10 Hz to 120 Hz, and a pulse width from 0.5 milliseconds to 5 milliseconds.

In further example embodiments of the method, the waste feed material can comprise Automotive Shredder Residue (ASR) feed material.

While the invention has been described in detail and with reference to specific embodiments thereof, it will be apparent to one skilled in the art that various changes and modifications can be made therein without departing from the spirit and scope thereof. Thus, it is intended that the present invention covers the modifications and variations of this invention provided they come within the scope of the appended claims and their equivalents.

It is intended that the present invention covers the modifications and variations of this invention provided they come within the scope of the appended claims and their equivalents. It is to be understood that terms such as “top”, “bottom”, “front”, “rear”, “side”, “height”, “length”, “width”, “upper”, “lower”, “interior”, “exterior”, and the like as may be used herein, merely describe points of reference and do not limit the present invention to any particular orientation or configuration.

What is claimed:

1. A photonic processing system comprising:
a reactor including a chamber that receives waste feed material that comprises a hydrocarbon material and an inorganic material, wherein the hydrocarbon material is present in the waste feed material in an amount of at least about 70% by weight of the waste feed material and the inorganic material comprises one or more metals and/or minerals;
a photonic illumination or photolysis module that irradiates the waste feed material within the chamber of the reactor to decompose the hydrocarbon material within the waste feed material into a gas or a mixture of gases, and a carbonaceous solid material; and
a mechanical movement unit that moves the waste feed material within the chamber of the reactor to facilitate exposure of different portions of the waste feed material to irradiation within the chamber during system operation.

2. The system of claim 1, wherein the photonic illumination or photolysis module comprises one or more xenon flash lamps, one or more light emitting diode (LED) lamps, one or more ultraviolet (UV) lamps, one or more infrared (IR) lamps, concentrated solar radiation, or one or more mercury-xenon flash lamps.

3. The system of claim 1, wherein the photonic illumination or photolysis module provides photonic energy within the chamber at voltage from 200V to 325V, a frequency from 10 Hz to 120 Hz, and a pulse width from 0.5 milliseconds to 5 milliseconds.

4. The system of claim 1, wherein, during system operation, the photonic illumination or photolysis module provides photonic energy in pulses within the chamber so as to raise exposed surface portions of the waste feed material within the chamber to at least 400° C. to facilitate decomposition of the waste feed material into gases and solids.

5. The system of claim 4, further comprising a solid collection module that receives the solid materials emerging from the reactor and separates the solid materials into the carbonaceous solid materials and an inorganic solid materials.

6. The system of claim 4, further comprising a gas line that receives syngas from the reactor and, provides energy from the syngas for operation of the reactor or feedstock for chemical or fuel production.

7. The system of claim 1, further comprising an inert gas supply that provides an inert gas to the chamber of the reactor to establish an inert gas atmosphere within the chamber during system operation.

8. The system of claim 1, further comprising a feeding unit that heats the waste feed material to a temperature above room temperature and provides the heated waste feed material to the chamber of the reactor.

9. The system of claim 1, further comprising:
a separation module that processes waste material to form the waste feed material delivered to the reactor, wherein the separation module comprises:
a sieving unit to separate larger waste material fractions from smaller waste material fractions based upon fraction size; and
one or more sifter units to separate the smaller waste material fractions into light components comprising a majority of hydrocarbon material and heavy components comprising a majority of inorganic material;
wherein the light components are provided as waste feed material from the separation module to an inlet of the chamber of the reactor.

10. The system of claim 9, wherein the smaller waste material fractions are no greater than 50 mm in size.

11. The system of claim 9, wherein the sieving unit further separates the smaller waste material fractions into medium waste material fractions having sizes ranging from 10 mm to 50 mm and fine waste material fractions having sizes less than 10 mm, and the one or more sifter units further comprises:
a first sifter unit that separates the medium waste material fractions into light components and heavy components; and
a second sifter unit that includes a shaker table to separate the fine waste material fractions into light components and heavy components.

12. The system of claim 9, further comprising one or more further separation units that separate the heavy components into metallic fractions and non-metallic fractions and further separate the metallic fractions into ferrous metallic fractions and non-ferrous metallic fractions.

13. The system of claim 1, wherein the waste feed material comprises Automotive Shredder Residue (ASR) feed material.

14. A method of converting waste feed material into a product that comprises a gas and a solid, the method comprising:
providing the waste feed material into a chamber of a reactor, wherein the waste feed material comprises a hydrocarbon material and an inorganic material, the hydrocarbon material is present in the waste feed material in an amount of at least about 70% by weight of the waste feed material, and the inorganic material comprises one or more metals;
irradiating the waste feed material within the chamber utilizing a photonic illumination or photolysis module to decompose the hydrocarbon material within the waste feed material into a gas and a carbonaceous solid material; and
moving the waste feed material within the chamber to facilitate exposure of different portions of the waste feed material within the chamber during the irradiating.

15. The method of claim 14, further comprising:
receiving solid material emerging from the reactor; and
separating the solid material into the carbonaceous solid material and an inorganic solid material.

16. The method of claim 14, further comprising:
removing inorganic material from waste material to form the waste feed material that is provided to the chamber of the reactor.

17. The method of claim 16, wherein the removing inorganic material from waste material comprises:
separating larger waste material fractions from smaller waste material fractions based upon fraction size; and
separating the smaller waste material fractions into light components comprising a majority of hydrocarbon material and heavy components comprising a majority of inorganic material;
wherein the light components are provided as waste feed material to an inlet of the chamber of the reactor.

18. The method of claim 17, wherein the smaller waste material fractions are no greater than 50 mm in size.

19. The method of claim 17, wherein the separating the smaller waste material fractions into light components further comprises:
separating the smaller waste material fractions into medium waste material fractions having sizes ranging from 10 mm to 50 mm and fine waste material fractions having sizes less than 10 mm, and the one or more sifter units further comprises:
separating the medium waste material fractions to form the light components and heavy components; and
separating the fine waste material fractions to form the light components and heavy components.

20. The method of claim 17, further comprising:
separating the heavy components into metallic fractions and non-metallic fractions; and
separating the metallic fractions into ferrous metallic fractions and non-ferrous metallic fractions.

21. The method of claim 14, wherein the waste feed material comprises Automotive Shredder Residue (ASR) feed material.
